(19) United States
(12) Patent Application Publication
(10) Pub. No.: US 2026/0154866 A1
(43) Pub. Date: Jun. 4, 2026

(54) GENERATING IMAGES

(71) Applicant: HEWLETT-PACKARD DEVELOPMENT COMPANY, L.P., Spring, TX (US)

(72) Inventors: Jordina TORRENTS BARRENA, Sant Cugat del Valles (ES); Rohan KHAITAN, Bangalore (IN); Jordi SANROMA GARRIT, Sant Cugat del Valles (ES)

(73) Assignee: HEWLETT-PACKARD DEVELOPMENT COMPANY, L.P., Spring, TX (US)

(21) Appl. No.: 19/125,225

(22) PCT Filed: Oct. 31, 2022
(86) PCT No.: PCT/US2022/078968

§ 371 Date: Apr. 28, 2025

(51) Int. Cl. G06T 11/23; G06T 7/12; G06T 11/60

(52) U.S. Cl. CPC G06T 11/23; G06T 7/12; G06T 11/60; G06T 2207/20216

(57) ABSTRACT

In an example, a method may include by processing circuitry identifying, in a first digital image, a first line section and determining a perimeter region around the first line section. It may be determined if a second line section has an end point within the perimeter region, and it may further be determined if the angle of the second line section is within a threshold of the angle of the first line section. When the second line section has an end point within the perimeter region and the angle of the second line section is within a threshold of the angle of the first line section, a second digital image may be generated having a line based on the first line section and the second line section.

### BACKGROUND

Vectorization is a process of converting information in digital images into a vector representation of that data. For example, an original image may be a pixel based, or raster, image, in which data is recorded for individual pixels, for example as a JPEG, GIFF, TIFF, BMP or PNG file. When such images are enlarged, the individual pixels may become visible. However, in a vector representation, or vector-based image, the pixels may be combined and the data is treated as lines or curves which maintain their resolution at any scale. Vectorization may be particularly useful in images which include clear lines, for example text, schematic images such as building plans, maps and the like. Examples of vector image files include scalable vector graphics (SVG) files, Adobe Illustrator artwork (.AI) files, Microsoft Visio drawing files, Portable Document Format (PDF) files, Drawing Exchange Format (DXF) files, DWG files and the like.

### BRIEF DESCRIPTION OF DRAWINGS

Non-limiting examples will now be described with reference to the accompanying drawings, in which:

FIG. 1 is a flowchart of an example method of determining a second digital image from a first digital image;

FIG. 2 is a flowchart of another example method of determining a second digital image from a first digital image;

FIGS. 3A and 3B are schematic examples showing how line sections may be combined or joined;

FIG. 4 is a flowchart of an example method of dividing a digital image into sub-portions for processing;

FIG. 5 is a schematic representation of an example of the method set out in FIG. 4;

FIG. 6 is an example of an apparatus comprising processing circuitry; and

FIG. 7 is an example of a machine-readable medium in association with a processor.

### DETAILED DESCRIPTION

In some examples, vectorization may be performed manually. For example, a user may perform a manual ‘trace’ operation, in which an underlying image is traced or marked up line by line by the user. While this can produce high quality results, it is labour-intensive. Many commercial products exist to perform automatic vectorization of image files, but the quality of the output of such products can be low. In particular, lines may be unintentionally broken, disconnected or appeared to overlap in the output image despite the lines being joined in the original image. Moreover, in some examples, lines may be intended to be orthogonal to one another but this alignment may be broken in the vectorization process.

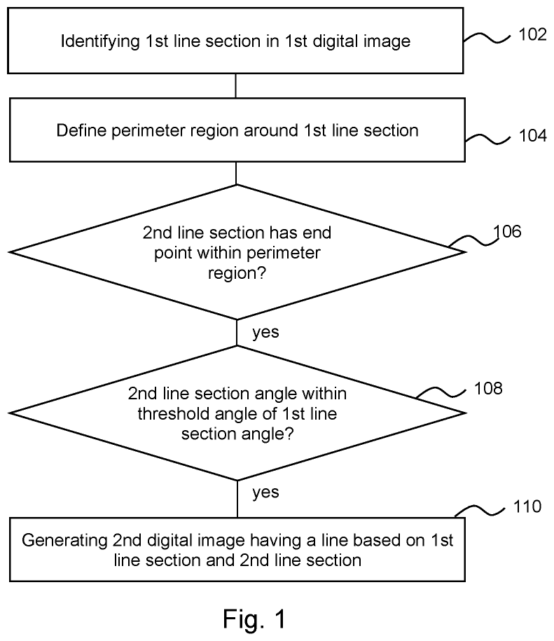

FIG. 1 is an example of a method, which may be implemented by processing circuitry, for example at least one processor of a computing device. The method of FIG. 1 processes a first digital image to produce a second digital image. For example, the method may group line sections in the first digital image such that these form the basis of a single line in the second digital image. The line sections may be grouped intelligently, for example on the basis of meeting predetermined criteria, as set out below.

Block 102 comprises identifying, in a first digital image, a first line section. The first digital image may comprise a vector image file, for example a scalable vector graphics file or the like. The image may be a ‘digital image’ in the sense that it is represented as data, and may for example be stored in a memory or the like. In some examples, the first digital image may comprise a vector image file which has been produced by a process of vectorization. As noted above, such processes can introduce anomalies, such as broken or disconnected lines.

In some examples, the first digital image is represented as data comprising a collection, or plurality, of vectors having a first point indicative of the location of a first end and a second point indicative of the location of a second end. In some examples, the first point and the second point may be specified as coordinates, for example XY coordinates or XYZ coordinates, of a coordinate system. The dimensions of the coordinate system may be arbitrary, for example being scalable such that the vectors of the vector file can be scaled to an intended size (i.e. the file is scalable in terms of the coordinates). A line section may be any vector of the first digital image, and/or may represent a continuous line in the first digital image. In some examples, the line section represents a continuous straight line. In some examples, the line section(s) may be associated with at lease one additional property, such as a line width, or a line color, or the like.

Block 104 comprises defining a perimeter region around the first line section. This may comprise a rectangular ‘boundary box’ fully enclosing the first line section. For example, there may be predetermined offset dimensions associated with the boundary box such that it includes a predetermined border around the line. For example, the boundary box may have a first spacing, for example m points (where ‘points’ are the smallest unit of measure to be used in the context), from the sides, or length, of the line and a second spacing, for example n points from the ends of the line. In some examples, m and n may be the same while in other examples they may be different. The boundary box may have an axis and/or edges which are aligned with the slope of the first line section. For example, a central axis of the perimeter region or boundary box may overlie or coincide with, the first line section. Moreover, in some examples, the central axis of the perimeter region may in some examples extend beyond at least one end of first line section. As further set out below, the size of the perimeter region may be configurable, for example by a user and/or on an iterative basis to produce an intended result.

Block 106 comprises determining if a second line section has an endpoint (wherein the endpoint may be either end of the second line section) within the perimeter region. For example, a coordinate indicative of an endpoint may be considered to determine if it lies within an area defined by the perimeter region. This may comprise, for example, considering all other line sections (or defined vectors) of the first digital image. For example, all line sections may be considered in a pairwise manner in processing the first digital image, in some examples with each line section being taken as the first line section in turn, such that they each have perimeter regions defined as described above, while the other line sections are considered to determine if they fulfil the criteria for the second line section in relation to that first line section. In other examples, a local area of the first image file may be searched to determine any second line sections meeting the criterion of being within the perimeter region of the first line section, for example using coordinates of an endpoint of the first line section, or using the coordinates of the perimeter region, or by subdividing the first digital image into subregions, or the like.

In some examples, instead or in addition to consideration of a local area, the line sections may be categorised based on their angle relative to a defined axis (for example, an X or Y axis of an orthogonal coordinate system in which the line sections are defined) and line sections which fall within the same category may be considered as candidates for first and second line sections. Examples in relation to this are discussed in greater detail below.

If such a second line section is identified, it is determined whether the angle of the second line section is within a threshold of the angle of the first line section in block 108. The angle of a line section may be defined as the angle at which the line section extends, for example relative to a defined axis such as the axes (e.g. an X and/or Y axis) of an orthogonal coordinate system in which the line section is defined. For example, it may be determined if the angle of the second line section is within between 0 and 3°, 0 and 5°, 0 and 7°, 0 and 10° or the like of the angle of the first line section.

When the second line section has an endpoint within the perimeter region and the angle of the second line section is within a threshold of the angle of the first line section, the method proceeds to block 110 which comprises generating a second digital image having a line based on the first line section and the second line section. In other examples, further line sections may be combined in this way as part of a method of processing the first digital image to form a second digital image. If the determination in blocks 106 and/or block 108 is negative, then a new first line section may be identified until all line sections in the first digital image have been inspected.

As will be described in greater detail below, the line in the second digital image may comprise a composite line to replace line sections which are linked during processing of the first digital image. Viewed another way, the first and second line sections may be combined to define the line. The line in the second digital image may comprise properties which may be an interpolation, for example a weighted average, of the properties of the line sections. For example, the line may have a point therein which is a coordinate wise average of the midpoints of the line sections. In some examples, the slope of the line may be computed as a weighted average of the slopes of the combined line sections. In other examples, other properties such as line width and/or colour may be determined or interpolated based on the corresponding properties of the line sections. In other examples, the line may have properties taken from the combined line sections. For example, the coordinates of the start and end point of the line may comprise coordinates of the start and end point of the end line sections of the line sections which are combined to form the line. In some examples, a property may be selected for the line which the most frequently seen property in the combined line section. For example, a line width or a line color may be selected on the basis that that width or color is seen for more line sections than any other width/color.

In some examples, the length of the line may be determined with reference to the endpoints of the combined line sections. For example, in an XY coordinate system, the lowest and highest X and Y coordinates of each of the line sections taken as a group may be determined and the line may be computed such that it does not extend outside a rectangle defined by these coordinates.

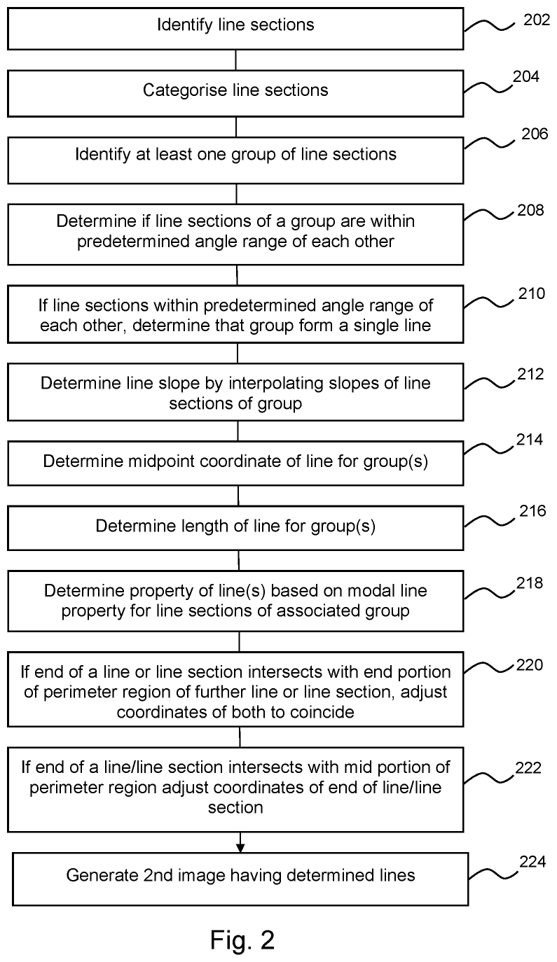

FIG. 2 is another example of a method of linking line sections. In this example, at least one group of line sections comprising two or more line sections is formed, and line sections within a group are used to form a line in the second digital image.

Block 202 comprises identifying a plurality of line sections in a first digital image, for example embodied as a digital image vector file, which may be the digital image described above in relation to FIG. 1. For example, this may identify each line section, or vector, within the file.

Block 204 comprises categorising the identified line sections based on their angle. In this example, the angle categories comprise (i) a horizontal line category for lines which extend within a first predetermined angular range, for example 0-5° or 0-10°, of a horizontal axis; (ii) a vertical line category for lines which extend within a second predetermined angular range, for example 0-5° or 0-10°, of a vertical axis; (iii) at least one sloped line category for lines which extend outside of the first and second predetermined angular ranges. In some examples, there may be two sloped line categories: a first slope category for line sections having a negative slope and a second line category for line sections having a positive slope. Other categories may be used in other examples.

Block 206 comprises identifying at least one group of line sections, the line sections of a group comprising line sections each of which (i) has an endpoint (i.e. either end) within the perimeter region of another line section of the group, and (ii) the angle of each line section is within a threshold of the angle of the perimeter region of that line section. In other words, the line sections are linked to form part of the group when the line sections satisfy a proximity criterion (i.e., in this example, an endpoint falls within the perimeter region of another line section of the group) and angle criterion (i.e. in this example, the angle of each line section is within a threshold of the angle of the perimeter region of the line section within which its endpoint is located). In some examples, the group may comprise the first and second line sections, as described above. In some examples, the group may also comprise at least one additional line section fulfilling the proximity criterion and the angle criterion. Moreover, in this example, all line sections in a group are taken from lines having the same angle category. Carrying out block 206 may comprise defining a perimeter region as described above in relation to block 104 for a plurality of identified line sections, or for each identified line section.

In some examples, groups may be formed iteratively. For example, a cluster of line sections may be defined from line sections fulfilling the proximity criterion and the angle criterion and, where these clusters have at least one member in common, the clusters may be combined to form a group.

Moreover, in some examples the groups may initially be formed without considering the relative angles therebetween. The groups may then be analysed and divided where the angles of the different line sections are greater than a threshold, for example using a DBSCAN algorithm or the like

Block 208 comprises determining, for each group, a range of angles associated with the line sections of that group (i.e., angles of extension of each line section). It may then be determined whether the range of angles falls within a predetermined range. For example, there may be a maximum defined difference in angles of around 5°, around 10°, or some other predetermined range. If the range of angles does fall within the range (as is assumed in the method of FIG. 2), the method proceeds to block 210, and it is determined that the line sections are to form the basis of a single straight line in the second digital image. If the line sections of the group differ by more than the predetermined range then, in some examples, the group may be divided until the angles do fall within a predetermined range. In other examples, it may be determined that the line sections are not to form part of a straight line but instead are to form part of a curve or the like.

In this example, on the assumption that the line sections are to form a straight line in the second digital image, the method proceeds to block 212 and the slope of the line of the second digital image for a given group is interpolated from the line sections of that group. In one example, the slope is determined as a weighted average of the slopes of the line sections of the group, wherein the weights are in proportion to the lengths of the line sections.

In other examples, the slope may be interpolated from the slopes of the line sections in some other way, for example as a simple average.

In some examples, line sections which are to be linked and which are in a ‘horizontal’ or ‘vertical’ category may be combined to form a line which is assigned the angle of being horizontal or vertical to match the category of the line sections. In other examples, where the slope of a line, for example on the basis of a weighted average of the slopes of line sections, is within a threshold angle of the horizontal or vertical (for example, a few degrees, such as 2° or 3°, or 5°), then the line may be assigned the angle of being horizontal or vertical. This may assist in preserving orthogonality, and may be of particular use in relation to images where horizonal and/or vertical lines are expected, such as architectural plans or the like.

Moreover, in block 214, a mid point, or intermediate, coordinate for the line of the second digital image to be formed for each group is determined by interpolating coordinates of the line sections of the group. For example, this may be determined as a weighted average of the geometric centre coordinates of the line sections of the group, wherein again the weights may be in proportion to the lengths of the line sections. The mid point of the line may be a geometric centre of the line, in that the line extends an equal distance on both sides thereof or may be any point in the line other than an endpoint. In some examples, while the mid point/intermediate coordinate may not be the exact geometrical centre, it may be close thereto.

In block 216, the length of the line of the second digital image may be determined. In one example, in an orthogonal coordinate system comprise X and Y axes, this is determined by determining the lowest x-coordinate associated with an endpoint of the group of line sections, a lowest y-coordinate associated with an endpoint of the group of line sections, a highest x-coordinate associated with the group of line sections and a highest y-coordinate associated with an endpoint group of line sections. A rectangle may be defined based on these coordinates, for example having sides parallel to the X and Y axes, and the line length may be determined such that the line does not extend beyond the defined rectangle.

While a particular method of determining the properties of the line are set out above, in other examples, other techniques may be used. For example, regression methods, random sample consensus (RANSAC) or the like may be used. In some examples, different methods may be used depending on properties of the first image and/or the line sections of a group. For example in groups of line sections which are relatively similar to one another, a RANSAC technique may be used. However, in groups of line sections which have more diversity, for example in terms of their angle of slope and/or length, a weighted average may be used as a RANSAC method may only take account of the start point and end points of the line, which may for example be given coordinates of the minimum and maximum x and y-coordinates of any endpoints (i.e. either end) of the line sections combined to form the line.

As mentioned above, in some examples where the line sections fulfil a proximity requirement but are determined not to contribute to a single straight line as their angles are not within the predetermined angle range, curve fitting methods (e.g., regression such as polynomial regression, Bezier fitting, function fitting, geometrical fitting, et cetera) may be used to fit a curve to the line sections, wherein the curve may form part of the second digital image.

In block 218, at least one property of the line(s) of the second digital image is determined as having a property which is seen most frequently amongst the line sections (i.e. the modal line property, or line property value of the line sections). For example, such a property may be a line width, or a line colour. In other examples, the line width/colour may be determined as an average (for example a weighted average) of any numerically defined property of the line sections, or may be selected or interpolated in some other way. This provides a line having at least one property which is representative of the combined property/properties of the line sections. In other examples, a line property may be determined in some other way. For example, the line may be defined as having a property (e.g. a width or colour) corresponding to that property as defined for a longest of the line sections of the group. In other examples, where there are two properties which are seen equally frequently within the group, the property associated with the cumulative longest line section(s) may be selected for the line of the second image.

Blocks 220 and 222 describe methods for joining lines or line sections such that they meet. In some examples, the line sections of an image may be assessed, grouped where they meet the criteria set out above, and line(s) may be determined based on any such groups. In such examples, block 220 and/or 222 may be carried out in relation to such lines, where determined, and any remaining line sections. In other examples, blocks 220 and 222 may be carried out in relation to line sections before lines are formed therefrom.

In these examples, each line section, or line formed based on a group of line sections, has a perimeter region defined so as to comprise a first portion associated with a first end of the line or line section, a second portion associated with a second end of the line/line section and a third portion associated with a mid section of the line/line section. In some examples, the size of the first and second portions may be predetermined and the size of the third portion may depend on the line/line section length. For example, the first and second portions may be defined as a rectangle enclosing the associated endpoint (i.e. either or both end of the line) as a midpoint thereof, or as a point on a central axis of the rectangle.

The rectangle may for example be defined as an i points by j points rectangle, where i and j may be any number, and may be the same or different to one another. In some examples, i and j, or the dimensions of the perimeter region as a whole, may be determined automatically based on the quality of the drawing which forms the basis of the first image. In other examples, i and j, or the dimensions of the perimeter region as a whole, may be determined by a user or the like. In some examples, the dimensions may be determined iteratively, for example starting off with a small defined perimeter region which may be increased in size if it is determined that the appropriate line linkage has not been performed in a first iteration. In some examples, an iteration may be reversed by a user if line sections which are intended to remain separate (e.g. dotted lines) are inadvertently joined. In such examples, it may be appropriate to decrease a size of a defined perimeter region to prevent such inadvertent joining of line sections.

In block 220, it is determined that an end of a particular line or line section (line/line section A) intersects with the first or second portion of a perimeter region of a further line or line section (line/line section B), but does not meet the angle criteria. In other words, it is determined that the ends of the two lines/line sections are close to one another but the relative angles thereof exceed the threshold. For example, this may comprise assessing that the angular difference is greater than 5°, or greater than 10°, or the like. In that case, it is determined that the end of line/line section A is to intersect with line/line section B in the second digital image. In such examples, generating the second digital image comprises adjusting at least one of coordinate associated with the first end of line/line section A and a coordinate associated with the end of line/line section B which is proximate to the first end of line/line section A such that the coordinates match one another following adjustment. Thus, in some examples, line/line section A and line/line section B form a corner (which may be a right angle, acute or obtuse) in the second digital image, despite possibly being discontinuous in the first digital image. In some examples, line/line section A may overlap, or cross, line/line section B, whereas in other examples, they may fail to meet in the first digital image. In some examples, if the angles are within a predetermined range of a right angle (e.g. within 3°, or within 5°), the coordinates may be adjusted such that the lines/line sections A and B form a right angle corner. This may assist in promoting orthogonality.

In block 222, it is determined that a first end of another particular line or line section (line/line section C) falls within a third, or mid, portion of the perimeter region of another line or line section (line/line section D), but does not meet the angle criteria. In such examples, it is determined that line/line section C is to intersect with line/line section D and, in such examples, generating the second digital image comprises adjusting a coordinate associated with the first end of line/line section C such that the adjusted coordinate of the first end of line/line section C intersects (and does not extend beyond) with a line formed based on line/line section D. In other words, the adjusted coordinate is on the path of line/line section D. In some examples, this may mean that line/line section C is adjusted to meet with line/line section D. Again, in some examples, if the angles of line/line sections C and D are within a predetermined range of a right angle (e.g. within 3°, or within 5°), the coordinates may be adjusted such that the lines/line sections C and D meet at a right angle. This may assist in promoting orthogonality.

In the above examples, in block 224, the second image is generated based on the linked line sections, in some examples having coordinates adjusted as set out above.

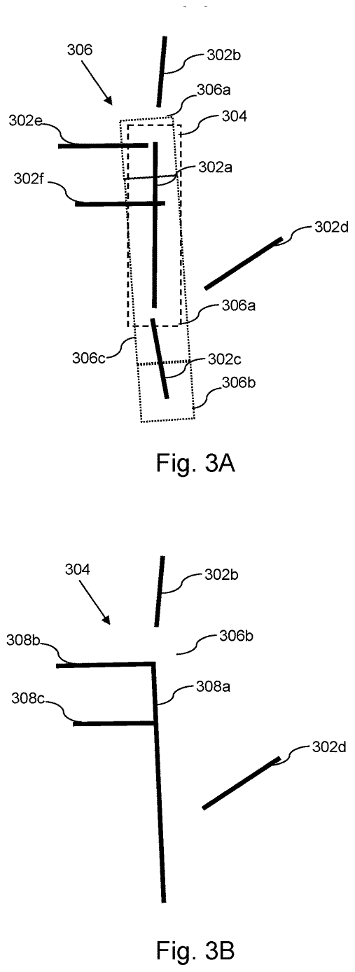

FIGS. 3A and 3B show a figurative example of how line sections may be linked according to the method set out in FIG. 1 and FIG. 2. In this example, six line sections 302a-d are shown. A first line section 302a has a perimeter region 304 shown associated there with.

In one example, the lines may be categorised according to their slope as described in relation to block 204 above. For example, the line sections 302a-c may be categorised in the vertical category, the line section 302d may be categorised as having a positive slope and the line sections 302e and 302f may be categorised as horizontal.

When considering which lines can be grouped with the first line section 302a, the method of FIG. 1, blocks 102 to 108, or of FIG. 2, block 206 may be applied. In particular, it may be seen that there are three other line sections having endpoints within the perimeter region 304. There are two line sections, 302b and 302c in the same category and extending at a similar angle to line section 302a, but only one of these, line section 302c has an endpoint which is within the perimeter region 304. Therefore, it may be determined that line section 302c may be grouped with line section 302a. Line section 302d does not intersect with the perimeter region, and is in a different slope category, therefore this does not form part of the group with line section 302a. While line sections 302e and 302f do intersect with the perimeter region 304, they are not in the same line category and extend at considerably different angles. Thus these are not candidates to form a group with line section 302a based on which a straight line may be formed.

As line sections 302a and 302c are grouped, a perimeter region 306 may be defined for the line formed based thereon. In this example, the perimeter region has three portions, a first end portion 306a, a second end portion 306b and a mid portion 306c. The methods of blocks 220 and 222 of FIG. 2 may be applied to determine that the endpoint of any line based at least in part on line section 302e and the endpoint of the line formed based on line sections 302a and 302c should have the same coordinates. Moreover, the endpoint of any line-based at least in part on line section 302f should meet, but not cross, a line based on line sections 302a and 302c.

FIG. 3B shows an example of how a second digital image may appear. The two line sections 302a and 302c have been combined to form a line 308a, which has a slope based on an interpolation of the slopes of the two line sections. Moreover, this line 308a forms a corner with line 308b, which is based on line section 302e having adjusted coordinates. In addition, line 308c, which is based on line section 302f, intersects with line 308a without overlap.

Thus, it may be appreciated that the overall number of vectors has been reduced. Moreover, small gaps and overlaps have been removed. Thus, the second digital image may be more compact in terms of the number of vectors described, and may also have an improved visual appearance to a viewer thereof. Moreover, it may better reflect the original image (for example a pixel based image) on which an initial vectorization was carried out to provide the first digital image.

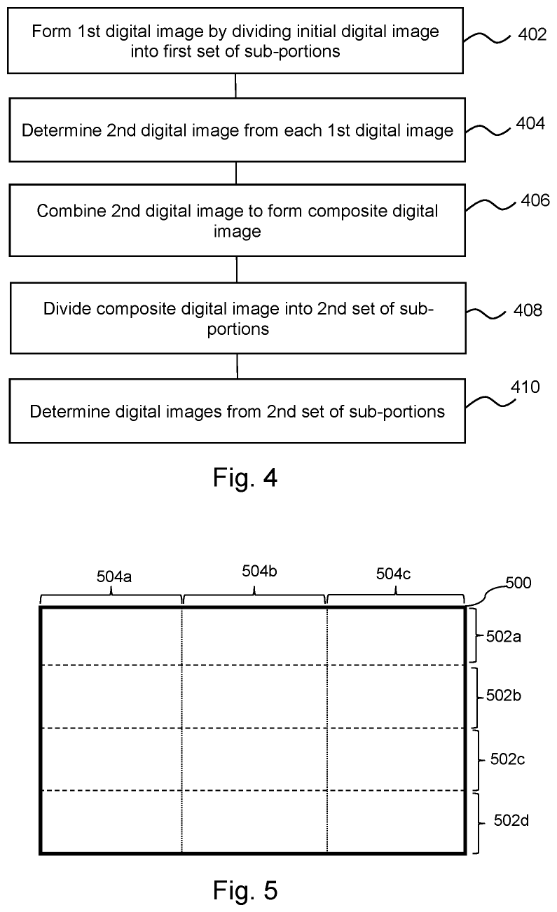

FIG. 4 is an example of a method which may be used in conjunction with any of the methods set out above, and may be carried out by processing circuitry, for example by one or more processors. In particular, the method of FIG. 4 may assist in running the method set out above in parallel, for example using a plurality of processors. This can result in processing an image more quickly.

FIG. 4 comprises, in block 402, forming the first digital image by dividing an initial digital image into a first set of sub-portions, where in each sub-portion comprises a first digital image. In block 404, the method of FIG. 1 or FIG. 2 may be carried out with respect to line sections of each first digital image to generate a second digital image for each first digital image. This provides a set of second digital images. Block 406 comprises determining a composite digital image which is based on the combined second digital images. It may be appreciated that, in this way, line sections within a sub-portion may be linked or grouped to generate lines. However, line sections which would have been grouped, but which span different subregions, may remain separate.

Therefore, the method proceeds to block 408 which comprises dividing the composite digital image into a second set of sub-portions, wherein the second set of sub-portions comprises at least one sub-portion which overlaps the boundaries between the sub-portions of the first set of sub-portions. In other words, this def ines a further set of digital images which comprise image(s) of the boundary regions of the first set of sub-portions (i.e. the first set of first digital images). The methods of FIG. 1 or FIG. 2 may then be carried out with respect to the line sections of each of these newly defined sub-portion(s). This will cause the line sections which crossed boundaries in the previous set to become linked as appropriate. A further composite digital image is formed based on the further set of digital images.

Each sub-portion of the initial image, or of the composite digital image, may be processed by a different processor. Thus, the method is readily adapted to parallelisation over a plurality of processors. In some examples, the number of sub-portions may be selected depending on the number of line sections in the initial image. For example, if the initial image contains a large number of line sections then more sub-portions may be defined than if the number of line sections is relatively small.

In addition to assisting in allowing the method to be carried out on different sub-portions of the image in parallel, this may allow long lines in the initial image to be more effectively linked as the linking is carried out iteratively.

FIG. 5 shows the process of FIG. 4 schematically. In this example, an initial digital image 505 is divided first into four horizontal slices, 502a-d. In an example, each of the slices 502a-d is treated as a first digital image as set out above. For example, the methods of FIG. 1 or FIG. 2 may be applied thereto. This may result in a reduction of the number of lines in each slice. The slices 502a-d are then combined into a composite image which is in turn sliced into three vertical slices 504a-c. The vertical slices 504a-c span the boundaries of the horizontal slices 502a-d and thus will identify line sections that should be joined to cross these boundaries. In another example, each of the ‘cells’ defined by intersections of horizontal and vertical slices (i.e. 12 cells in the example of FIG. 5) may be treated as a first digital image, then in a second iteration these may be combined to represent at least one of a vertical slice 504a-c and horizontal slice 502a-d.

While the number of slices/sub-portions formed at each stage is purely illustrative, it may be that, in operation of the method, the number of slices or sub-portions into which the initial image is divided may reduce as the method progresses as there may be fewer operations to perform in a second stage compared to a first stage.

While in the example above, horizontal slices were taken in one iteration and vertical slices were taken in another iteration, this need not be the case in all examples. For example, a further set of horizontal slices which are offset from the horizontal slices 502a-c would also span the boundaries therebetween. Moreover, while in the illustrated example, the slices span the full width or height of the initial image, this need not be the case in all examples. Furthermore, slices or sub-portions may be defined on a diagonal, or in some other way. In general, the method may proceed by identifying relatively small regions of an initial image, then progressively larger regions, with the number of line sections tending to decrease at each iteration or over a plurality of iterations.

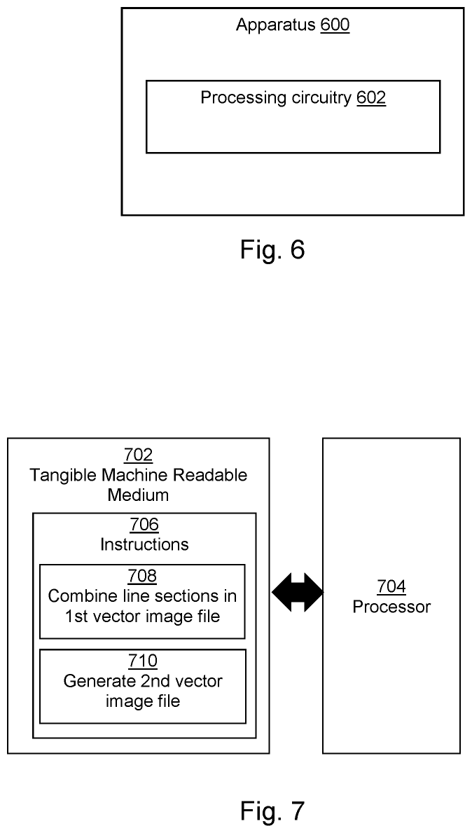

FIG. 6 schematically shows an example computing device 600 comprising processing circuitry 602. In use of the computing device 600, the processing circuitry 602 generates a second digital image file from a first digital image file by linking (or grouping) line sections in the first image file when the line sections satisfy a proximity criterion and angle criterion. As set out above, the proximity criterion may be that an endpoint falls within the perimeter region (or boundary box) of another line section. In other examples, the proximity criterion may be defined in another way, for example based on the absolute distance between the closest endpoints of the line sections. As set out above, the criterion may be that each line section is within a threshold of the angle of the line section which satisfies the proximity criterion in order to be linked (or grouped). Moreover, in some examples, the angle criterion may further comprise a determination that the line sections to be linked fall within a same category of angles of extension. For example, as set out above, line sections may be categorised, for example into categories such as (i) vertical, or near vertical, (ii) horizontal or near horizontal, (iii) having a negative slope or (iv) having a positive slope.

The processing circuitry 602 may be further configured such that generating the second digital image file comprises generating a composite line to replace linked line sections, the composite line having properties based on combined properties of the linked line sections. The properties of the composite line may comprise at least one of a slope, a thickness, a midpoint, a colour or the like. At least one property may be determined based on an interpolation of the corresponding properties of the line sections linked to form the line, for example as described above, e.g. as a weighted average. In other examples, at least one property may be determined based on a modal value of the corresponding property of the linked line sections, for example as described in greater detail above.

In some examples, the property may comprise a slope comprising a weighted average of the slopes of the linked line sections. In some examples, the property may comprise a thickness comprising a weighted average of the thicknesses of the linked line sections. In some examples the property may comprise a point (i.e, a location or point along the line, or an intermediate point) comprising a weighted average of the midpoints of the linked line sections. In some examples, the weighted averages may be determined using the relative lengths of the lines as the weight.

The processing circuitry 602 may be configured to carry out any of the methods described above in relation to FIG. 1, 2 or 4.

FIG. 7 shows a non-transitory machine-readable medium 702 in association with a processor 704. The machine readable medium 702 stores instructions 706 readable and executable by the processor 704 to cause the processor 704 to carry out tasks.

The instructions 706 comprise instructions 708 to cause the processor 704 to combine line sections in a first vector image file by identifying, in the first vector image file, a first line section and a second line section, wherein the second line section has an endpoint (i.e. either end of the line section) which lies within a boundary box about the first line section and a relationship between an angle of the first line section and the second line section meets a predetermined criterion. The first vector image file may comprise any of the features of the first digital image or the first digital image file described above. Each line section may comprise a vector of the first vector image file, for example representing a straight line which may in some examples be associated with properties such as a line width or color. Moreover, the boundary box may have any of the features of the perimeter region described above. Executing these instructions may comprise carrying out any or any combination of the methods of blocks 102 to 108 or any or any combination of blocks 202 to 210.

The instructions 706 further comprise instructions 710 to cause the processor 704 to generate a second vector image file having a line based on the first line section and the second line section. The second vector image file may comprise any of the features of the second digital image or the second digital image file described above. For example, this may comprise carrying out block 110 or block 224.

The instructions 706 may further comprise instructions to cause the processor 704 to determine a slope for the line comprising an interpolation of the slopes of the first and second line sections for example as a weighted average. Other properties may also be determined by interpolating properties of the first and second line sections, or in any of the ways set out above.

The instructions 706 may further comprise instructions to cause the processor 704 to carry out any or any combination of blocks 212 to 222 as described above.

Aspects of some examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that at least one block in the flow charts, as well as combinations of the blocks in the flow charts can be realized by machine readable instructions.

The machine readable instructions may, for example, be executed by a general purpose computer, a special purpose computer, an embedded processor or processors of other programmable data processing devices to realize the functions described in the description and diagrams, and which may for example comprises at least part of the processing circuitry 602. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising, by processing circuitry:
identifying, in a first digital image, a first line section;
determining a perimeter region around the first line section;
determining if a second line section has an endpoint within the perimeter region;
determining if the angle of the second line section is within a threshold of the angle of the first line section; and
when the second line section has an endpoint within the perimeter region and the angle of the second line section is within a threshold of the angle of the first line section, generating a second digital image having a line based on the first line section and the second line section.

2. A method according to claim 1 further comprising forming a group of line sections comprising the first and second line section and any additional line section which has an endpoint within the perimeter region of another line section of the group wherein the angle of the additional line section is within a threshold of the angle of the another line section.

3. A method according to claim 2 further comprising assessing if the line sections of the group of line sections are associated with angles which fall within a predetermined range and, if so, determining that the line is a straight line.

4. A method according to claim 1, wherein the line of the second digital image has a slope which is a weighted average of the slopes of the first line section and the second line section, wherein the weights are in proportion to the lengths of the line sections.

5. A method according to claim 1 wherein the line of the second digital image has a mid point coordinate which is a weighted average of the centre coordinates of the first line section and the second line section, wherein the weights are in proportion to the lengths of the line sections.

6. A method according to claim 1 wherein the line of the second digital image has a line property of a longest of the first and second line sections.

7. A method according to claim 1 further comprising:
identifying a plurality of line sections in the first image file;
categorising the identified line sections based on their angle;
and wherein the first and second line sections are selected from identified line sections in a same category.

8. A method according to claim 6 wherein the categories comprise:
a horizontal line category for lines which extend within a first predetermined angular range of a horizontal axis;
a vertical line category for lines which extend within a second predetermined angular range of a vertical axis;
at least one sloped line category for lines which extend outside of the first and second predetermined angular ranges.

9. A method according to claim 1 further comprising defining a perimeter region for the line formed based on the first and second line sections, wherein the perimeter region has a first portion associated with a first end of the line, a second portion associated with a second end of the line and a third portion associated with a mid section of the line, the method further comprising, when an end of a third line section intersects with the third portion of the perimeter region, determining that the third line section is to intersect with the line; and wherein generating the second digital image comprises adjusting a coordinate associated with the end of the third line section such that the adjusted coordinate of the end of the third line section intersects with the line.

10. A method according to claim 1 further comprising defining a perimeter region for the line formed based on the first and second line sections, wherein the perimeter region has a first portion associated with a first end of the line, a second portion associated with a second end of the line and a third portion associated with a mid section of the line, the method further comprising, when a first end of a third line section intersects with the first or second portion of the perimeter region, determining that the third line section is to intersect with the line; and wherein generating the second digital image comprises:
adjusting at least one of a coordinate associated with the first end of the third line section and a coordinate associated with the end of the line which is proximate to the first end of the third line section such that the coordinates match one another following the adjustment.

11. A method according to claim 1 comprising:
forming a set of first digital images by dividing an initial digital image into a first set of sub-portions,
generating a set of second digital images according to the method of claim 1,
providing a composite digital image based on the combined second digital images;
dividing the composite digital image into a second set of sub-portions, wherein the second set of sub-portions comprise at least one sub-portion which overlaps a boundary between sub-portions of the first set of sub-portions;
carrying out the method of claim 1 with respect to line sections of the second set of sub-portions to generate a further set of digital images; and
forming a second composite digital image based on the further set of digital images.

12. A computing device comprising processing circuitry to:
generate a second digital image file from a first digital image file by linking line sections in the first image file when the line sections satisfy a proximity criterion and angle criterion;
wherein generating the second digital image file comprises generating a composite line to replace linked line sections, the composite line having properties based on combined properties of the linked line sections.

13. A computing device according to claim 12 wherein the properties of the composite line comprise at least one of:
a slope comprising a weighted average of the slopes of the linked line sections;
a thickness comprising a weighted average of the thickness of the linked line sections;
an intermediate point comprising a weighted average of the midpoints of the linked line sections; and
a colour comprising a modal colour of the linked line sections.

14. A non-transitory machine-readable medium storing instructions readable and executable by a processor to:
combine line sections in a first vector image file by identifying, in the first vector image file, a first line section and a second line section, wherein the second line section has an endpoint which lies within a boundary box about the first line section and a relationship between an angle of the first line section and the second line section meets a predetermined criterion; and
generate a second vector image file having a line based on the first line section and the second line section.

15. The non-transitory machine-readable medium of claim 14 further storing instructions readable and executable by a processor to:
determine a slope for the line based on an interpolation of the slopes of the first and second line sections.
